(19) United States
(12) Patent Application Publication
(10) Pub. No.: US 2022/0393978 A1
(43) Pub. Date: Dec. 8, 2022

(54) PACKET PROCESSING METHOD, FORWARDING DEVICE, AND PACKET PROCESSING SYSTEM

(71) Applicant: HUAWEI TECHNOLOGIES CO., LTD., Shenzhen (CN)

(72) Inventors: Wenzhuo ZHANG, Chengdu (CN); Kai XU, Chengdu (CN)

(21) Appl. No.: 17/889,701

(22) Filed: Aug. 17, 2022

Related U.S. Application Data
(63) Continuation of application No. PCT/CN2021/074967, filed on Feb. 3, 2021.

(30) Foreign Application Priority Data
Feb. 18, 2020 (CN) 202010100254.6

(51) Int. Cl. H04L 45/74

(52) U.S. Cl. CPC H04L 45/74

(57) ABSTRACT

A packet processing method, a forwarding device, and a packet processing system are applied to a switch, a router, or another device or system in which a control plane and a forwarding plane are separated. In the packet processing method, the forwarding device obtains a first forwarding table that corresponds to a first packet and that is configured by a control device, where the first forwarding table includes at least one data structure, and the at least one data structure includes a field value type and content corresponding to the field value type. Then, the forwarding device processes the first packet based on a field value type in the at least one data structure and content corresponding to the field value type, to obtain a field value of a field value type. Therefore, packet processing efficiency is improved.

### CROSS-REFERENCE TO RELATED APPLICATIONS

This application is a continuation of International Application No. PCT/CN2021/074967, filed on Feb. 3, 2021, which claims priority to Chinese Patent Application No. 202010100254.6, filed on Feb. 18, 2020. The disclosures of the aforementioned applications are hereby incorporated by reference in their entireties.

### BACKGROUND

Protocol oblivious forwarding (POF) is a software-defined networking (SDN)-based southbound protocol. An architecture defined by in POF includes a POF control device of a control plane and a POF forwarding device of a data plane. The POF forwarding device is oblivious of a protocol, and locates data, performs matching, and performs a corresponding operation based on {offset, length} only under guidance of the POF control device, to complete packet processing. Therefore, the POF forwarding device may complete packet processing without considering the protocol. In this case, to support a new protocol, the forwarding device does not need to be upgraded, and only a corresponding forwarding entry needs to be delivered by using the POF control device.

In the foregoing POF solution, the forwarding device needs to sequentially parse an offset and a length in each group in the forwarding table, and process a field corresponding to the offset and the length in each group. Consequently, a quantity of accessing a memory is increased, and processing efficiency is low.

### SUMMARY

Embodiments described herein provide a packet processing method, a forwarding device, and a packet processing system, to improve packet processing efficiency.

According to a first aspect, an embodiment provides a packet processing method. The packet processing method relates to a forwarding device, and includes the following steps: The forwarding device receives a first packet, and obtains a first forwarding table that corresponds to the first packet and that is configured by a control device. The first forwarding table includes at least one data structure, and the at least one data structure includes a field value type and content corresponding to the field value type. Then, the forwarding device processes the first packet based on a field value type in the at least one data structure and content corresponding to the field value type, to obtain a field value of a field value type.

According to a second aspect, an embodiment provides a forwarding device. The forwarding device includes a processor and a memory. The memory is configured to store a plurality of forwarding tables. The plurality of forwarding tables include a first forwarding table corresponding to a first packet, the first forwarding table includes at least one data structure, and the at least one data structure includes a field value type and content corresponding to the field value type. The processor is configured to: receive the first packet, obtain, from the memory, the first forwarding table that corresponds to the first packet and that is configured by the control device, and process the first packet based on a field value type in the at least one data structure and content corresponding to the field value type, to obtain a field value of a field value type.

According to a third aspect, embodiments described herein provide a data structure. The data structure includes a field value type and content corresponding to the field value type, and at least one data structure forms one forwarding table.

According to a fourth aspect, embodiments described herein provide a forwarding table. The forwarding table is configured by a control device. The forwarding table includes one or more data structures according to any one of the third aspect and the implementations of the third aspect.

According to a fifth aspect, embodiments described herein provide a control device. The control device is configured to: configure, for a forwarding device, a forwarding table described in the fourth aspect, and transmit the forwarding table to the forwarding device.

According to a sixth aspect, embodiments described herein provide a packet processing system. The packet processing system includes a control device and a forwarding device. The control device is adapted to configure one or more forwarding tables corresponding to a first packet. The forwarding device is configured to: obtain the one or more forwarding tables, and process the first packet based on the one or more forwarding tables, to implement the method according to any one of the first aspect and the implementations of the first aspect.

According to a seventh aspect, an embodiment described herein provides a computer program product including instructions. In response to the computer program product running on a computer, the computer is enabled to perform the method according to any one of the first aspect and the implementations of the first aspect.

According to an eighth aspect, an embodiment described herein provides a computer-readable storage medium, including instructions. The instructions include the forwarding table described in any one of the first aspect and the implementations of the first aspect. In response to the instructions running on a computer, the computer is enabled to perform the method according to any one of the first aspect and the implementations of the first aspect.

### BRIEF DESCRIPTION OF DRAWINGS

FIG. 1 is a diagram of an application scenario of a packet processing method according to at least one embodiment;

FIG. 2A is a schematic diagram of an embodiment of a forwarding table configured by a control device according to at least one embodiment;

FIG. 2B is a schematic diagram of another embodiment of a forwarding table configured by a control device according to at least one embodiment;

FIG. 3 is a flowchart of a packet processing method according to at least one embodiment;

FIG. 4 is another flowchart of a packet processing method according to at least one embodiment;

FIG. 5A is a schematic diagram of an embodiment of a packet processing method according to at least one embodiment;

FIG. 5B is a schematic diagram of another embodiment of a packet processing method according to at least one embodiment;

FIG. 6 is another flowchart of a packet processing method according to at least one embodiment;

FIG. 7 is a schematic diagram of another embodiment of a packet processing method according to at least one embodiment;

FIG. 8 is a schematic diagram of an embodiment of a forwarding device according to at least one embodiment;

FIG. 9 is a schematic diagram of an embodiment of a control device according to at least one embodiment; and

FIG. 10 is a schematic diagram of an embodiment of a packet processing system according to at least one embodiment.

### DESCRIPTION OF EMBODIMENTS

The following clearly and completely describes technical solutions in embodiments described herein with reference to the accompanying drawings. The described embodiments are merely some rather than all of embodiments.

In the specification, claims, and the accompanying drawings, the terms “first”, “second”, “third”, and the like are intended to distinguish similar objects but do not necessarily indicate a specific order or sequence. The data termed in such a way is interchangeable in proper circumstances, so that embodiments described herein are implemented in an order other than the order illustrated or described herein. In addition, the terms “include”, “have” and any other variants thereof are intended to cover non-exclusive inclusion. For example, a process, method, system, product, or device that includes a list of steps or units is not necessarily limited to those steps or units that are expressly listed, but includes other steps or units that are not expressly listed or inherent to the process, method, product, or device.

The term “and/or” in this specification describes only an association relationship between associated objects and represents that three relationships exist. For example, A and/or B represent the following three cases: Only A exists, both A and B exist, and only B exists. In addition, the character “/” in this specification usually indicates an “or” relationship between the associated objects.

Embodiments described herein provide a packet processing method, a forwarding device, and a packet processing system, to improve packet processing efficiency.

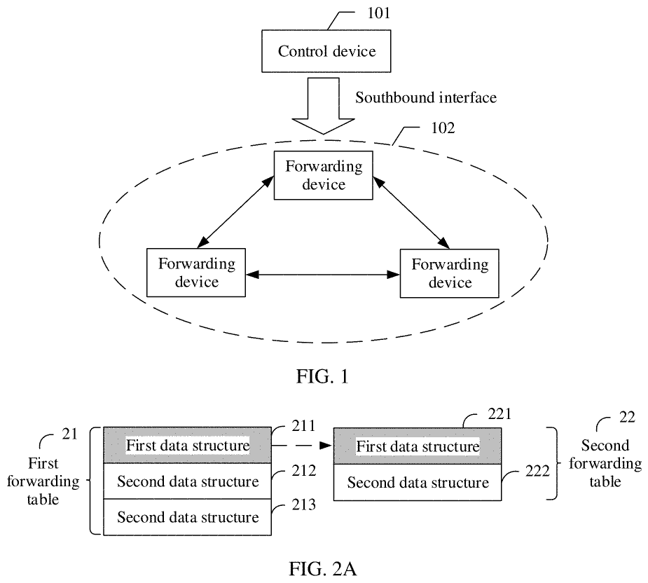

A packet processing method provided in according to at least one embodiment is mainly applied to a packet processing scenario in which control and forwarding are separated. FIG. 1 is used as an example. A control device 101 sends a forwarding table to a forwarding device 102 through a southbound interface. Then, a forwarding device 102 processes a received packet based on the forwarding table in the packet processing method provided in at least one embodiment, to improve packet processing efficiency.

The forwarding device 102 is a switch, for example, a protocol oblivious forwarding (POF) switch, or an openflow switch. The forwarding device 102 is alternatively a routing device (router), for example, a router. The forwarding device 102 is alternatively a gateway device, or the like that performs a series of operations based on the forwarding table. This is not specifically limited herein. In addition, the control device 101 is a controller, for example, a software-defined networking (SDN) controller. In response to the forwarding device 102 being a switch, the control device 101 is a controller that generates various forwarding tables, to control, based on the various forwarding tables, packet processing performed by a switch. In response to the forwarding device 102 being a router, the controller 101 is a controller that generates various routing tables, to control, based on the various routing tables, packet processing performed by a router. This is not specifically limited herein.

The forwarding device 102 is any one of the foregoing devices or a chip in the device. This is not specifically limited herein. Regardless of being used as a device or a chip, the forwarding device 102 is manufactured, sold, or used as an independent product. In this embodiment and a subsequent embodiment, the forwarding device is only used as an example for description.

Before the packet processing method provided in this embodiment described herein, the forwarding table provided is first described.

The forwarding table is also referred to as a flow table, and is configured (or generated) by the control device. Specifically, the control device configures the forwarding table based on a forwarding procedure in which a system forwards various services of a database driver. The forwarding table includes at least one data structure. The data structure is understood as a processing command that is independently executed by the forwarding device. In response to the forwarding table including a plurality of data structures, at least two of the plurality of data structures is simultaneously executed by the forwarding device. In response to there being a plurality of data structures in the forwarding device, the forwarding device simultaneously executes at least two of the plurality of data structures.

A data structure includes a field value type and content corresponding to the field value type. The field value type is also referred to as a field type, and indicates a type of an action indicated by the data structure. The field value type is also understood as a type of a packet processing action performed by the forwarding device in response to the forwarding device executing the data structure. The content corresponding to the field value type is information used by the forwarding device in response to an action corresponding to a field value type in the data structure is executed. The content corresponding to the field value type is also understood as data used for implementing the action corresponding to the field value type.

In response to the forwarding table including only one data structure, the data structure is a first data structure. In response to the forwarding table including a plurality of data structures, the plurality of data structures include one first data structure and one or more second data structures. The first data structure is also referred to as a primary data structure, and the second data structure is also referred to as a forwarding data structure. In at least one embodiment, a name of the data structure in an actual application is not limited. A field value type in the first data structure includes an interface, a search, unicast, multicast, routing, encapsulation, discarding, abnormal, or the like. A field value type in the second data structure includes parsing, editing, mirroring, fragmentation/recombination, compression, encryption, sorting, statistics collection, retransmission, a logical operation, assignment, or the like. In an actual application, data structures of different field value types is used in different scenarios, and a specific combination manner is not limited herein.

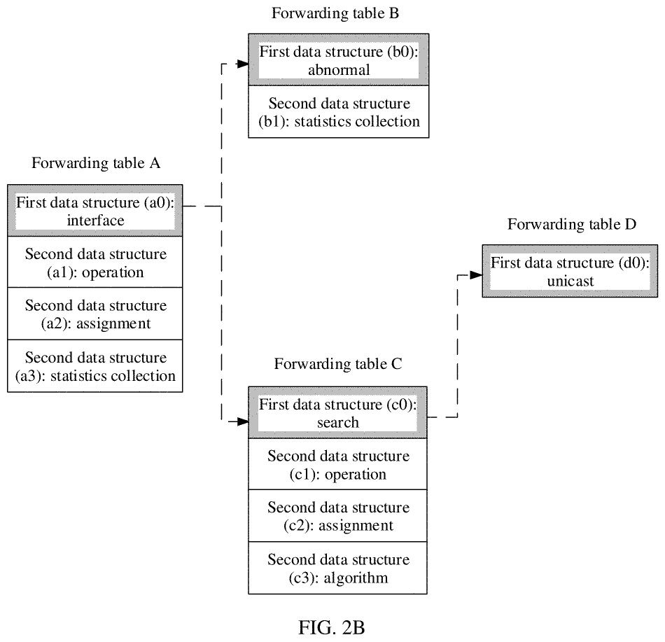

The first data structure is connected to one of the plurality of second data structures, and there is also a connection relationship between the plurality of second data structures. For ease of understanding, a forwarding table 21 in FIG. 2A is used as an example for description. The forwarding table 21 includes a plurality of data structures. Specifically, the forwarding table 21 includes one first data structure (for example, a first data structure 211) and a plurality of second data structures (for example, a second data structure 212 and a second data structure 213). The first data structure 211 is connected to the second data structure 212, and the second data structure 212 is connected to the second data structure 213.

That two data structures are connected means that the two data structures are associated in response to being executed by the forwarding device. In response to executing one of the two data structures, the forwarding device learns of existence of the other data structure, and trigger execution of the other data structure. Specifically, in response to the two data structures being connected, one of the two data structures includes one piece of identification information, and the identification information is used to indicate another data structure connected to the data structure. For example, the identification information is a storage address of the another data structure. The forwarding table 21 in FIG. 2A is still used as an example. The first data structure 211 in the forwarding table 21 includes one piece of identification information, and the identification information is used to indicate the second data structure 212 connected to the first data structure 211; similarly, the second data structure 212 includes one piece of identification information, and the identification information is used to indicate the second data structure 213 connected to the second data structure 212, and so on. Details are not described again.

Optionally, there is also a connection relationship between a plurality of forwarding tables. Specifically, a connection between one forwarding table and another forwarding table is implemented by using a connection between a first data structure in the forwarding table and a first data structure in the another forwarding table. The forwarding table 21 in FIG. 2A is used as an example. The first forwarding table 21 includes the first data structure 211, the second data structure 212, and the second data structure 213. The first forwarding table 22 includes the first data structure 221 and the second data structure 222. The first data structure 211 includes one piece of identification information, and the identification information is used to indicate the first data structure 221. Therefore, the first forwarding table 21 and the second forwarding table 22 are connected based on the identification information in the first data structure 211 and the identification information in the first data structure 221. In other words, in response to executing the first data structure 211 in the first forwarding table 21, the forwarding device learns of existence of the first data structure 221 in the second forwarding table 22.

The plurality of forwarding tables forms a chain-like distribution or a tree-like distribution by using a connection between various first data structures. FIG. 2B is used as an example. A forwarding table A, a forwarding table B, a forwarding table C, and a forwarding table D form a tree-like distribution. A field value type in a first data structure (a0) in the forwarding table A is “interface”, and field value types of second data structures in the forwarding table A are respectively “operation”, “assignment”, and “statistics collection”. The first data structure (a0) in the forwarding table A is connected to both a first data structure (b0) in the forwarding table B and a first data structure (c0) in the forwarding table C, a field value type in the first data structure (b0) in the forwarding table B is “abnormal”, and a field value type in the first data structure (c0) in the forwarding table C is “search”. In addition, a field value type in a second data structure connected to the first data structure (b0) in the forwarding table B is “statistics collection”. Field value types of sequentially connected second data structures below the first data structure (c0) in the forwarding table C are respectively “operation”, “assignment”, and “algorithm”. In addition, the first data structure (c0) in the forwarding table C is further connected to the first data structure (d0) in the forwarding table D, and a field value type in the first data structure (d0) is “unicast”. There are different connection relationships between forwarding tables in response to data structures with different field value types forming different forwarding tables. In FIG. 2B, a field value type is shown, and content corresponding to a field value type is omitted, but content corresponding to a field value type does not exist in a data structure in at least one embodiment.

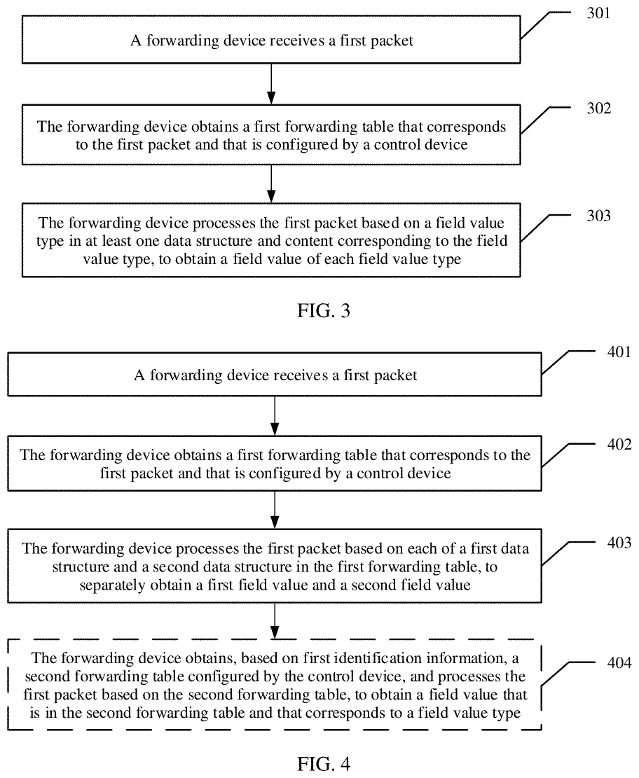

The following describes a packet processing method in an embodiment based on the foregoing forwarding tables including various data structures. As shown in FIG. 3, steps performed by a forwarding device in the packet processing method include the following steps.

301: The forwarding device receives a first packet.

The first packet is from another forwarding device connected to the forwarding device, for example, a routing and forwarding device or a switch forwarding device; or is from another non-forwarding device, for example, a service gateway, a signaling gateway, a security gateway, a server, or a terminal device. This is not specifically limited herein.

302: The forwarding device obtains a first forwarding table that corresponds to the first packet and that is configured by a control device.

Because the forwarding device processes the first packet based on a data structure in a forwarding table, the forwarding device obtains the first forwarding table corresponding to the first packet, and the first forwarding table is configured by the control device. The forwarding device directly obtains, from the control device, the first forwarding table corresponding to the first packet. Alternatively, the control device directly sends, to the forwarding device, the first forwarding table corresponding to the first packet. Alternatively, the control device stores, in a network management device or another external storage device, the first forwarding table corresponding to the first packet, and the forwarding device obtains, from the network management device or the another external storage device, the first forwarding table corresponding to the first packet. This is not specifically limited herein. Optionally, the forwarding device stores the first forwarding table in a memory in the forwarding device. Therefore, the memory in the forwarding device is also referred to as a table memory.

The first forwarding table includes at least one data structure, and the at least one data structure includes a field value type and content corresponding to the field value type. For a specific structure of the first forwarding table, refer to related descriptions corresponding to FIG. 2A. For definitions of the field value type and the content corresponding to the field value type, refer to related descriptions in the foregoing embodiments. For details, the details are not described herein again.

303: The forwarding device processes the first packet based on a field value type in the at least one data structure and content corresponding to the field value type, to obtain a field value of a field value type.

The field value indicates a processing result of an action indicated by the data structure. The field value is one or more values calculated by the forwarding device, or is a character or field obtained by the forwarding device from the first packet, or is one or more characters configured by the forwarding device based on the content corresponding to the field value type. In at least one embodiment, a specific value of the field value is not limited.

After obtaining the first forwarding table, the forwarding device parses the first forwarding table, to determine composition of the data structure in the first forwarding table, in other words, determine a field value type in a data structure and content corresponding to the field value type. Then, the forwarding device processes the first packet based on the field value type in the at least one data structure and the content corresponding to the field value type, to obtain the field value of a field value type. For example, the first forwarding table includes a first data structure and a second data structure, and the first data structure includes a first field value type and content corresponding to the first field value type. The second data structure includes a second field value type and content corresponding to the second field value type. In this case, the forwarding device processes the first packet based on the first field value type and the content corresponding to the first field value type, to obtain a first field value, and the forwarding device processes the first packet based on the second field value type and the content corresponding to the second field value type, to obtain a second field value. Similarly, in response to the first forwarding table including a plurality of data structures, the forwarding device separately processes the first packet based on the plurality of data structures, to obtain a plurality of field values.

In this embodiment, a forwarding table is configured by the control device as a plurality of data structures that is processed in parallel. After the forwarding device obtains the first forwarding table, the forwarding device processes, based on the field value type in the at least one data structure and the content corresponding to the field value type, the first packet corresponding to the first forwarding table. In other words, the forwarding device processes a plurality of data structures in a same forwarding table in parallel. Therefore, compared with the conventional technology in which data in a same forwarding table is parsed sequentially, in this embodiment, packet processing efficiency is improved.

Based on the packet processing method corresponding to FIG. 3, in response to data structures in the first forwarding table being further defined, the data structures is associated in sequence. Therefore, the forwarding device triggers processing of another data structure in response to reading one data structure. The following describes this solution. As shown in FIG. 4, steps performed by the forwarding device in the packet processing method include the following steps.

401: The forwarding device receives a first packet.

Step 401 is similar to step 301. Reference is made to related descriptions in step 301. Details are not described herein again.

402: The forwarding device obtains a first forwarding table that corresponds to the first packet and that is configured by a control device.

The forwarding device directly obtains, from the control device, the first forwarding table corresponding to the first packet; or indirectly obtains, from a network management device or another external storage device, the first forwarding table corresponding to the first packet. The first forwarding table in the network management device or the another external storage device is configured by the control device. Specifically, reference is made to related descriptions in step 302. Details are not described herein again. The first forwarding table is stored in a table memory in the forwarding device.

The first forwarding table includes at least one data structure, and the at least one data structure includes a field value type and content corresponding to the field value type.

In an optional implementation, the at least one data structure includes a first data structure. In this case, the first data structure includes at least one piece of first identification information in addition to a first field value type and content corresponding to the first field value type. The first identification information is used to indicate a first primary data structure in a second forwarding table connected to the first forwarding table, and the second forwarding table corresponds to the first packet. FIG. 2A is used as an example. A first data structure 211 in a first forwarding table 21 includes one piece of first identification information, and the first identification information is used to indicate a first data structure 221 in a second forwarding table 22 connected to the first forwarding table 21.

In another optional implementation, the at least one data structure includes one first data structure and one or more second data structures. The first data structure includes one piece of second identification information in addition to a first field value type, content corresponding to the first field value type, and first identification information. The second identification information is used to indicate a second data structure that is in the first forwarding table and that is connected to the first data structure. Optionally, the second data structure further includes one piece of third identification information, and the third identification information is used to indicate another second data structure that is in the first forwarding table and that is connected to the second data structure. FIG. 2A is still used as an example. A first data structure 211 in a first forwarding table 21 includes one piece of second identification information, and the second identification information is used to indicate a second data structure 212 that is in the first forwarding table 21 and that is connected to the first data structure 211.

In subsequent step 403 and step 404, that the first forwarding table includes one first data structure and one second data structure is only used as an example for description. However, in an actual application, the first forwarding table includes a plurality of second data structures in addition to one first data structure. This is not specifically limited herein.

403: The forwarding device processes the first packet based on the first data structure and the second data structure in the first forwarding table, to separately obtain a first field value and a second field value.

Specifically, the forwarding device reads the first data structure in the first forwarding table, obtains the second identification information from the first data structure, and reads, based on the second identification information, the second data structure that is in the first forwarding table and that is connected to the first data structure. Optionally, the forwarding device obtains the second identifier information from content corresponding to the first field value type in the first data structure. Then, the forwarding device processes the first packet based on a combination of the first field value type in the first data structure and the content corresponding to the first field value type and a combination of the second field value type in the second data structure and the content corresponding to the second field value type, to obtain the first field value and the second field value.

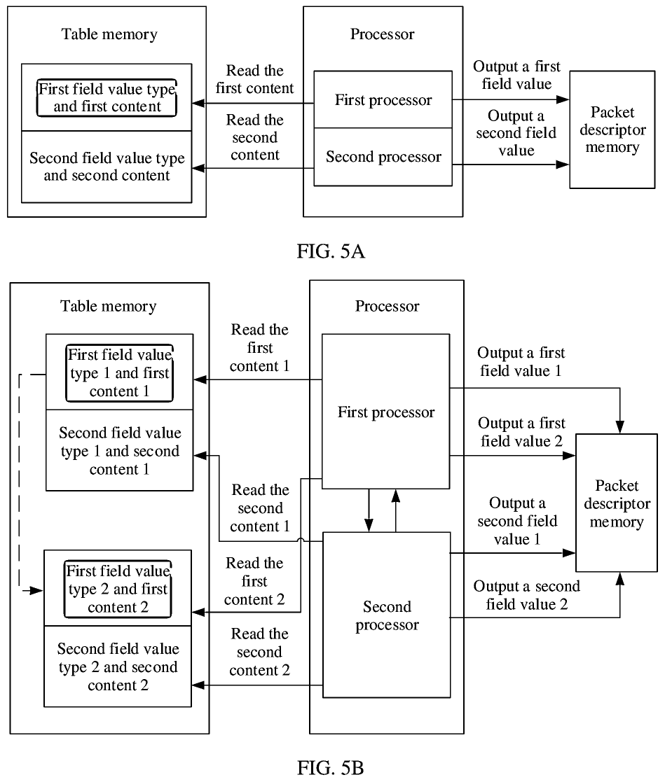

The following describes the foregoing steps with reference to an internal structure of the forwarding device. FIG. 5A is a schematic diagram of an internal structure of a forwarding device. As shown in FIG. 5A, the forwarding device includes a processor, a table memory, and a packet descriptor memory. The processor includes a first processor and a second processor. The first processor is configured to process a first data structure in a forwarding table. The second processor is configured to process a second data structure in a forwarding table. The table memory is configured to store a forwarding table. The packet descriptor memory is configured to store intermediate data generated in a packet processing process. For example, the processor outputs a field value. In response to the forwarding device processing the first packet based on the first data structure and the second data structure, the first processor of the forwarding device reads the first field value type in the first data structure and first content (briefly referred to as the first content hereinafter) corresponding to the first field value type, determines a storage address of the second data structure based on second identification information in the first content corresponding to the first field value type (namely, a storage address of the second data structure in the table memory), and sends the storage address of the second data structure to the second processor. In addition, the first processor processes the first packet based on the first field value type and the first content corresponding to the first field value type, and stores the determined first field value in the packet descriptor memory. After the second processor receives the storage address of the second data structure, the second processor reads, from a corresponding address in the table memory, the second field value type in the second data structure and second content (briefly referred to as the second content hereinafter) corresponding to the second field value type. Then, the second processor processes the first packet based on the second field value type in the second data structure and the second content corresponding to the second field value type, and stores the determined first field value in the packet descriptor memory.

A time period consumed to determine the storage address of the second data structure by the first processor based on the second identification information and a time period consumed to send the second data structure to the second processor are extremely short, and are far less than a time period for processing the first packet by the first processor based on the first field value type and the first content and a time period for processing the first packet by the first processor based on the second field value type and the second content. Therefore, a process in which the first processor processes the first packet based on the first field value type and the first content and a process in which the second processor processes the first packet based on the second field value type and the second content are performed in parallel. Therefore, efficiency of processing the first packet by the forwarding device is improved.

404: The forwarding device obtains, based on the first identification information, the second forwarding table configured by the control device, and processes the first packet based on the second forwarding table, to obtain a field value that is in the second forwarding table and that corresponds to a field value type.

The second forwarding table is related to the first packet. To be specific, the second forwarding table is used to provide, for the forwarding device, data for processing the first packet. The forwarding device processes the first packet based on a field value type in a data structure in the second forwarding table and content corresponding to the field value type, to obtain the field value that is in the second forwarding table and that corresponds to the field value type.

Step 404 is optional. In response to the forwarding device performing step 404, the forwarding device simultaneously performs step 403 and step 404.

The process is described below with reference to FIG. 5B. In responses to the first processor in the forwarding device reading a first field value type 1 in the first forwarding table and first content 1 (briefly referred to as the first content 1 hereinafter) corresponding to the first field value type 1, the first processor determines a storage address of the second data structure in the first forwarding table based on second identification information in the first content 1, and the first processor further determines a storage address of a first data structure in the second forwarding table based on first identification information in the first content 1. In response to the first processor processing the first packet based on the first field value type 1 and the first content 1, the first processor reads, from the storage address of the first data structure in the second forwarding table, a first field value type 2 in the second forwarding table and first content 2 (briefly referred to as the first content 2 hereinafter) corresponding to the first field value type 2. In this case, the first processor immediately processes the first content 2 after completing processing of the first content 1, without consuming time to perform an operation such as resolving an address, or reading the first field value type 2 and the first content 2. Therefore, the first processor quickly outputs a first field value 1 corresponding to the first field value type 1 and a first field value 2 corresponding to the first field value type 2, and store the first field value 1 and the second field value 2 in the packet descriptor memory. Further, processing efficiency of the first processor is improved. In other words, processing efficiency of the forwarding device is improved.

Similarly, in the second processor of the forwarding device, in response to the second processor processing the first packet based on the second field value type 1 in the first forwarding table and the second content 1 (briefly referred to as the second content 1 hereinafter) corresponding to the second field value type 1, the second processor further receives a storage address of a second data structure in the second forwarding table from the first processor. In this case, after the second processor completes processing of the first packet based on the second field value type 1 and the second content 1, the second processor processes the first packet based on a second field value type 2 in the second forwarding table and second content 2 (briefly referred to as the second content 2 hereinafter) corresponding to the second field value type 2. This further helps increase a rate at which the second processor outputs a second field value 1 corresponding to the second field value type 1 and a second field value 2 corresponding to the second field value type 2, to improve efficiency of processing the first packet by the second processor.

In this embodiment, the first packet corresponds to a plurality of forwarding tables. In response to the forwarding device processing the first packet based on a data structure in the first forwarding table, the forwarding device further parses an address of the second forwarding table, so that after completing processing of the first packet based on the first data structure in the first forwarding table, the first processor in the forwarding device immediately processes the first packet based on the first data structure in the second forwarding table. Therefore, efficiency of processing the first packet by the forwarding device is improved.

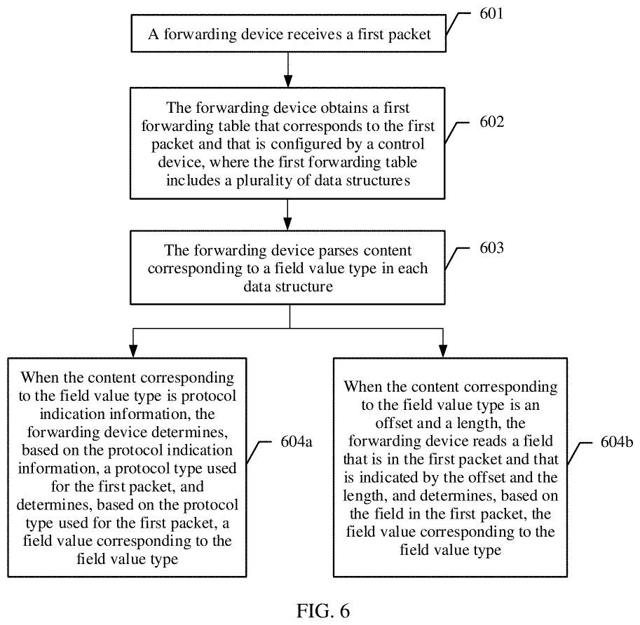

Based on the foregoing implementations, in an optional implementation, the content corresponding to the field value type in a data structure also affects efficiency of processing the first packet by the forwarding device. The following describes this solution. As shown in FIG. 6, steps performed by the forwarding device in the packet processing method include the following steps.

601: The forwarding device receives a first packet.

Step 601 is similar to step 401. Reference is made to related descriptions in step 401. Details are not described herein again.

602: The forwarding device obtains a first forwarding table that corresponds to the first packet and that is configured by a control device, where the first forwarding table includes a plurality of data structures.

Step 602 is similar to step 402. Reference is made to related descriptions in step 402. Details are not described herein again.

603: The forwarding device parses content corresponding to a field value type in a data structure.

In an optional implementation, the content corresponding to the field value type includes protocol indication information, and the protocol indication information is used to indicate a protocol type used for the first packet. The protocol indication information is not a protocol name, but is a field that reflects the protocol type. The protocol indication information includes at least one of the following: a virtual local area network (VLAN) identifier, a media access control (MAC) address, and an internet protocol (IP) address, a multiprotocol label switching (MPLS) label, a port number, and an automatic protection switching (APS) field. For ease of understanding, the IP address is used as an example for description. The IP address is an IPv4-based IP address or an IPv6-based IP address. in response to a field value type in a first data structure of a data structure being an interface, in response to content corresponding to the field value type including an IP address, the IP address is any one or more of an IP address indicating a transmission control protocol (TCP), an IP address indicating a user datagram protocol (UDP), an IP address indicating an internet control message protocol (ICMP), an IP address indicating an internet group management protocol (IGMP), or an IP address indicating a stream control transmission protocol (SCTP). In an actual application, the foregoing IP addresses is combined. This is not specifically limited herein. Similarly, a protocol type used for a packet is alternatively determined based on a VLAN identifier, a MAC address, an MPLS label, a port number, or the like. Details are not described herein again.

In another optional implementation, the content corresponding to the field value type includes an offset and a length, and the offset and the length are used to indicate a location that is of a field read by the forwarding device and that is in the first packet. For example, content corresponding to a field value type in a data structure is {offset=16 bits, length=8 bits }. “Offset=16 bits” indicates that a pointer starts to read data from a location that has an offset of 16 bits relative to a start bit of a header of the first packet, and “length=8 bits” indicates that the forwarding device reads 8-bit data in response to reading data in the first packet.

604a: In response to the content corresponding to the field value type being protocol indication information, the forwarding device determines, based on the protocol indication information, the protocol type used for the first packet, and determines, based on the protocol type used for the first packet, a field value corresponding to the field value type.

604b: In response to the content corresponding to the field value type being an offset and a length, the forwarding device reads a field that is in the first packet and that is indicated by the offset and the length, and determines, based on the field in the first packet, the field value corresponding to the field value type.

In this embodiment, the forwarding table includes a plurality of data structures, and field value types in various data structures corresponding to different content. Therefore, there is a case in which first content corresponding to a first field value type in a first data structure in a same forwarding table is protocol indication information, and second content corresponding to a second field value type in a second data structure is an offset and a length. Therefore, in a process in which the forwarding device processes the first packet, step 604a and step 604b coexists. To be specific, in a forwarding table that includes only a first data structure and a second data structure, there is the following four cases:

(1) First content corresponding to a first field value type in the first data structure is protocol indication information, and second content corresponding to a second field value type in the second data structure is an offset and a length.

(2) First content corresponding to a first field value type in the first data structure is an offset and a length, and second content corresponding to a second field value type in the second data structure is protocol indication information.

(3) First content corresponding to a first field value type in the first data structure and second content corresponding to a second field value type in the second data structure are protocol indication information, and a protocol that is used for the first packet and that is indicated by the first content is the same as or different from a protocol that is used for the first packet and that is indicated by the first content.

(4) First content corresponding to a first field value type in the first data structure and second content corresponding to a second field value type in the second data structure are an offset and a length.

In response to the forwarding table including one first data structure and a plurality of second data structures, there is a more complex case of content corresponding to field value types in data structures in a same forwarding table. For details, the details are not described herein. However, In response to content corresponding to a plurality of field value types parsed by the forwarding device being protocol indication information, the forwarding device processes the first packet more quickly based on a supported protocol. When content corresponding to a plurality of field value types parsed by the forwarding device is mainly an offset and a length, the forwarding device supports a user-defined protocol, to help improve flexibility of processing the first packet by the forwarding device.

A sequence of performing step 604a and step 604b is determined based on a sequence of processing data structures by the forwarding device in step 403 and step 404. For details, refer to related descriptions in step 403 and step 404. Details are not described herein again.

In this embodiment, the forwarding table is configured by the control device as a plurality of data structures that is processed in parallel. After the forwarding device obtains the first forwarding table, the forwarding device processes, based on a field value type in at least one data structure and content corresponding to the field value type, the first packet corresponding to the first forwarding table. Therefore, packet processing efficiency is improved. In addition, in response to the content corresponding to the plurality of field value types parsed by the forwarding device being mainly protocol indication information, the forwarding device processes the first packet more quickly based on the supported protocol. In response to the content corresponding to the plurality of field value types parsed by the forwarding device being mainly an offset and a length, the forwarding device supports the user-defined protocol, to help improve flexibility of processing the first packet by the forwarding device.

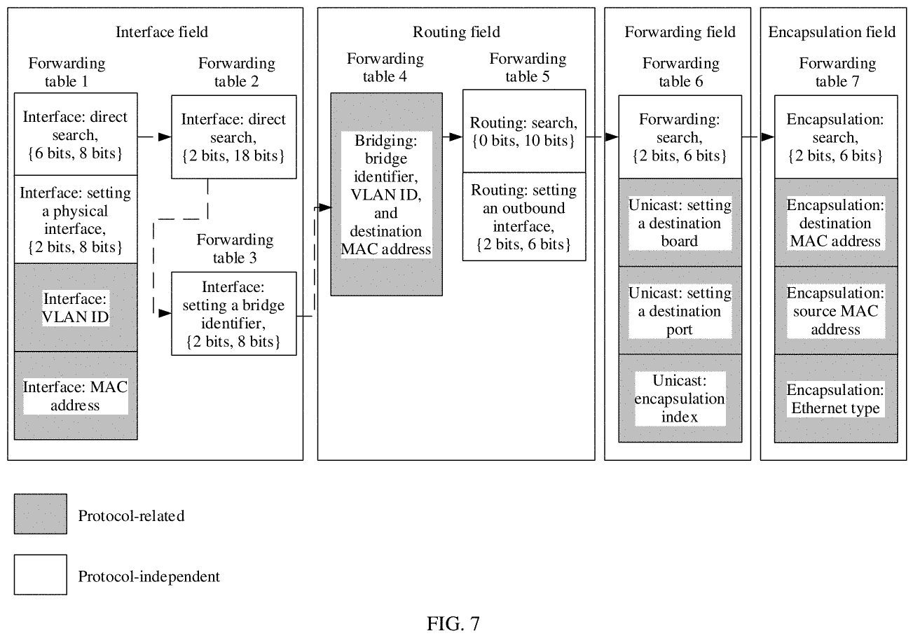

The following describes the packet processing method with reference to a virtual private LAN segment (VPLS) scenario. FIG. 7 shows a plurality of forwarding tables used for completing a VPLS service by a forwarding device. As shown in FIG. 7, the plurality of forwarding tables used for a VPLS service processing procedure are classified by field, including an interface field, a routing field, a forwarding field, or an encapsulation field. A field includes one or more forwarding tables. For example, the interface field includes a forwarding table 1 and a forwarding table 2, the routing field includes a forwarding table 4 and a forwarding table 5, the forwarding field includes a forwarding table 6, and the encapsulation field includes a forwarding table 7. A forwarding table includes one or more data structures, and a protocol-related data structure (namely, content corresponding to a field value type in the data structure is protocol indication information) and a protocol-independent data structure (namely, content corresponding to a field value type in the data structure includes an offset and a length) exists in a same forwarding table. For example, a first data structure (namely, a primary data structure) in the forwarding table 1 is a protocol-independent data structure. A field value type in the first data structure in the forwarding table 1 is “interface”, and content corresponding to the field value type is “direct search, {6 bits, 8 bits}”. For another example, a first data structure (namely, a primary data structure) in the forwarding table 4 is a protocol-related data structure. A field value type in the first data structure in the forwarding table 4 is “bridging”, and content corresponding to the field value type is “bridge identifier, VLAN ID, and destination MAC address”. For another example, a second data structure (namely, a forwarding data structure) in the forwarding table 5 is a protocol-independent data structure. A field value type in the second data structure in the forwarding table 5 is “routing”, and content corresponding to the field value type is “setting an outbound interface, {2 bits, 6 bits}”. Another data structure is similar to those in the example. For details, the details are not described herein again.

Specifically, in the interface field, in response to reading a data structure in the forwarding table 1, the forwarding device makes a direct search at location at which an offset is 6 bits and a length is 8 bits in a packet 1 corresponding to the forwarding table 1. In addition, the forwarding device further sets a physical interface, and writes the physical interface to a location at which an offset is 2 bits and a length is 8 bits in the packet 1. Then, the forwarding device separately parses protocol indication information a VLAN ID and a MAC address, to determine a protocol type used for the packet 1. Then, the forwarding device reads a data structure in the forwarding table 2, and searches for and obtain a logical interface at a location at which an offset is 2 bits and a length is 18 bits in a packet 1 corresponding to the forwarding table 2. Then, the forwarding device reads a data structure in a forwarding table 3, and sets a bridge identifier at a location at which an offset is 2 bits and a length is 8 bits in a packet 1 corresponding to the forwarding table 3, to complete a search for the bridge identifier.

In the routing field, the forwarding device reads a data structure in the forwarding table 4, and searches a bridge forwarding table by using a bridge identifier, a VLAN ID, and a destination MAC address as keywords. In response to reading a data structure in the forwarding table 5, the forwarding device makes a search at a location at which an offset is 0 bits and a length is 10 bits in a packet 1 corresponding to the forwarding table 5. In addition, the forwarding device further sets an outbound interface, and writes the outbound interface to a location at which an offset is 2 bits and a length is 6 bits in the packet 1.

In the forwarding field, the forwarding device reads a data structure in the forwarding table 6, and makes a search at a location at which an offset is 2 bits and a length is 6 bits in a packet 1 corresponding to the forwarding table 6. Then, processing of switch network information including information such as a destination board, a destination port, or an encapsulation table index is completed.

In the encapsulation field, the forwarding device reads a data structure in the forwarding table 7, and makes a search at a location at which an offset is 2 bits and a length is 6 bits in a packet 1 corresponding to the forwarding table 7. Then, encapsulation of an Ethernet header including information such as a destination MAC address, a source MAC address, or an Ethernet type is completed.

In the foregoing embodiments, a bit value of the offset and bit data of the length are merely used as examples. In an actual application, the bit value of the offset and the bit value of the length is different from those in the foregoing example. Specifically, the bit value of the offset and the bit value of the length are not limited in this embodiment.

The foregoing describes the packet processing method provided in embodiments described herein. The following describes a specific structure of a forwarding device used in executing the packet processing method.

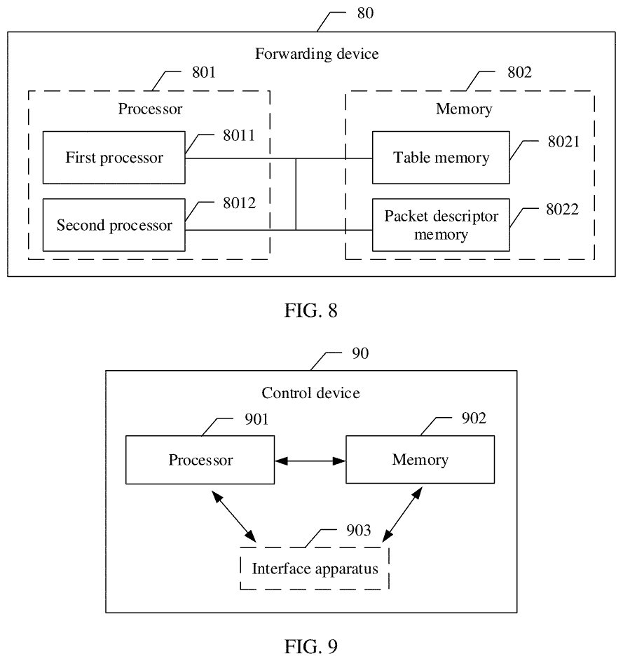

FIG. 8 is a schematic diagram of a structure of a forwarding device 80 according to an embodiment. The structure of the forwarding device 80 shown in FIG. 8 in at least one embodiment is used for the forwarding device in the method embodiments corresponding to FIG. 3, FIG. 4, and FIG. 6. In addition, the forwarding device in the examples corresponding to FIG. 5A and FIG. 5B is combined with the forwarding device 80 shown in FIG. 8 according to at least one embodiment.

The forwarding device 80 includes at least one processor 801 and at least one memory 802. The processor 801 is also referred to as a message processor or a packet processor, and is configured to: process a data structure (for example, the first data structure and the second data structure, or the primary data structure and the forwarding data structure) and a packet (for example, the first packet) in a forwarding table, control the entire forwarding device, execute a software program, and process data of the software program, for example, is configured to support the forwarding device 80 in performing the actions described in the foregoing embodiments. The processor 801 in the forwarding device 80 includes a first processor 8011 and a second processor 8012. The first processor 8011 is configured to process a first data structure (or a primary data structure) in a forwarding table. The second processor 8012 is configured to process a second data structure (or a forwarding data structure) in a forwarding table. The first processor 8011 and the second processor 8012 is two independent processors, or is two independent modules having different functions in the processor 801. This not specifically limited herein. Data exchange is performed between the first processor 8011 and the second processor 8012. For example, the first processor 8011 sends, to the second processor 8012, a storage address of the second data structure indicated by second identification information in the first data structure.

The memory 802 is mainly configured to store data such as forwarding tables configured by a control device, a packet, and field values output by the processor 801, for example, a first forwarding table, a second forwarding table, a first packet, a first field value, and a second field value. The memory 802 exists independently, and is connected to the processor 801. Alternatively, the memory 802 is integrated with the processor 801, for example, integrated into one or more chips. The memory 802 is further configured to store program code for executing the technical solutions in embodiments described herein. The processor 801 controls execution of the program code. Various types of executed computer program code is also considered as drivers of the processor 801. Optionally, the memory 802 includes a table memory 8021 and a packet descriptor memory 8022. The table memory 8021 is configured to store packet-related forwarding tables (for example, the first forwarding table and the second forwarding table). The packet descriptor memory 8022 is configured to store data generated by the processor 801 in a packet processing process. The data is the field values (for example, the first field value and the second field value) that a correspond to a field value type and that are output by the processor 801.

FIG. 8 shows an example of a forwarding device having one table memory and one packet descriptor memory. During actual application, the forwarding device 80 includes a plurality of table memories or a plurality of packet descriptor memories. This not limited herein.

Specifically, the processor 801 is configured to: obtain the first forwarding table that corresponds to the first packet and that is configured by the control device, and store the forwarding table in the table memory 8021. The first forwarding table includes at least one data structure, and the at least one data structure includes a field value type and content corresponding to the field value type. In addition, the processor 801 is further configured to: process the first packet based on a field value type in the at least one data structure and content corresponding to the field value type, to obtain a field value of a field value type, and store a field value in the packet descriptor memory 8022. For other steps, refer to the steps performed by the forwarding device in the embodiments corresponding to FIG. 3, FIG. 4, and FIG. 6. Details are not described herein again.

FIG. 9 is a schematic diagram of a structure of a control device 90 according to at least one embodiment described herein. The structure of the control device 90 shown in FIG. 9 in at least one embodiment is used for the control device in the method embodiments corresponding to FIG. 3, FIG. 4, and FIG. 6.

The control device 90 includes at least one processor 901 and at least one memory 902. The processor 901 is configured to: configure forwarding tables (for example, the first forwarding table and the second forwarding table) that correspond to a packet, control the entire control device, execute a software program, and process data of the software program, for example, is configured to support the control device 90 in performing the actions described in the foregoing embodiments.

The memory 902 is mainly configured to store forwarding tables configured by the control device, for example, the first forwarding table and the second forwarding table. The memory 902 exists independently, and is connected to the processor 901. Optionally, the memory 902 is alternatively integrated with the processor 901, for example, integrated into one or more chips. The memory 902 is further configured to store program code for executing the technical solutions in embodiments described herein. The processor 901 controls execution of the program code. Various types of executed computer program code is also considered as drivers of the processor 901.

Optionally, the control device 90 further includes an interface apparatus 903, configured to connect to a forwarding device or an external memory, and the forwarding tables are output through the interface apparatus 903. Optionally, the interface apparatus 903 is a southbound interface.

One processor and one memory are shown in FIG. 9. During actual application, the control device 90 has a plurality of processors or a plurality of memories. This not specifically limited herein. For other steps, refer to steps performed by the control device in the foregoing embodiments. Details are not described herein again.

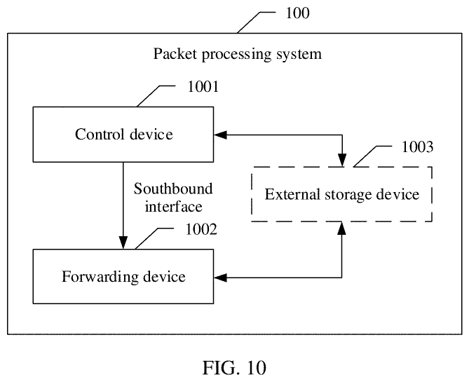

FIG. 10 is a schematic diagram of a structure of a packet processing system 100 according to an embodiment described herein. As shown in FIG. 10, the packet processing system 100 includes a control device 1001 and a forwarding device 1002. The control device 1001 and the forwarding device 1002 are connected through a southbound interface. Specifically, for a specific structure of the forwarding device 1002, refer to the embodiment corresponding to FIG. 8. For a specific structure of the control device 1001, refer to the embodiment corresponding to FIG. 9. Details are not described herein again.

Optionally, the packet processing system 100 further includes an external storage device 1003, configured to store a forwarding table configured by the control device 1001, so that the forwarding device 1002 obtains the forwarding table from the external storage device 1003. Optionally, the external storage device 1003 further stores a packet, and the forwarding device 1002 receives the packet from the external storage device 1003.

The forwarding device has functional units corresponding to steps of a method or a procedure performed by a forwarding device. One or more of the foregoing modules or units is implemented by using software, hardware, or a combination thereof. In response to any one of the foregoing modules or units being implemented by using software, the software exists in a form of computer program instructions, and is stored in a memory. A processor is configured to execute the program instructions to implement the foregoing method procedures.

The processor in at least one embodiment includes but is not limited to at least one of the following computing devices that run various types of software: a central processing unit CPU, a microprocessor, a digital signal processor (DSP), a microcontroller unit (MCU), a network processor (NP), an artificial intelligence processor, or the like. A computing device includes one or more cores configured to perform an operation or processing by executing software instructions. The processor is a separate semiconductor chip; or is integrated with another circuit into a semiconductor chip, for example, forms a system-on-a-chip (SoC) with another circuit (for example, an encoding/decoding circuit, a hardware acceleration circuit, or various bus and interface circuits); or is integrated into an application-specific integrated circuit (ASIC) as a built-in processor of the ASIC. The ASIC integrated with the processor is packaged separately or is packaged together with another circuit. The processor includes a core for executing software instructions to perform operation or processing, and further includes a hardware accelerator, for example, a field programmable gate array (FPGA), a programmable logic device (PLD), or a logic circuit that implements a special-purpose logic operation.

The memory in at least embodiment includes at least one of the following types: a read-only memory ROM or another type of static storage device that stores static information and instructions, or a random access memory RAM or another type of dynamic storage device that stores information and instructions, or is an electrically erasable programmable read-only memory (electrically erasable programmable read-only memory, EEPROM). This not specifically limited herein.

In at least one embodiment, same reference numerals in different accompanying drawings is considered as a same object. For explanations of same reference signs between the foregoing accompanying drawings, reference is mutually made between each other, unless otherwise specified. A person skilled in the art clearly understand that, for the purpose of convenient and brief description, for detailed working processes of the foregoing system, apparatus, and unit, refer to corresponding processes in the foregoing method embodiments. Details are not described herein again.

The foregoing embodiments are merely used to describe the technical solutions, but not to limit scope of embodiments described herein. Although embodiments are described in detail, persons of ordinary skill in the art understand that modifications are able to be made to the technical solutions described in the foregoing embodiments or equivalent replacements to some technical features thereof, without departing from the spirit and scope of the technical solutions.

What is claimed is:

1. A packet processing method, comprising:
receiving, by a forwarding device, a first packet;
obtaining, by the forwarding device, a first forwarding table that corresponds to the first packet and that is configured by a control device, wherein the first forwarding table includes at least one data structure, and the at least one data structure includes a field value type and content corresponding to the field value type; and
processing, by the forwarding device, the first packet based on a field value type in the at least one data structure and content corresponding to the field value type, to obtain a field value of a field value type.

2. The method according to claim 1, wherein the at least one data structure includes a first data structure, the first data structure includes at least one piece of first identification information, the first identification information is used to indicate a first primary data structure in a second forwarding table connected to the first forwarding table, and the second forwarding table corresponds to the first packet.

3. The method according to claim 2, wherein the at least one data structure further includes one or more second data structures, the first data structure further includes one piece of second identification information, and the second identification information is used to indicate a second data structure that is in the first forwarding table and that is connected to the first data structure; and
the processing, by the forwarding device, the first packet based on a field value type in the at least one data structure and content corresponding to the field value type includes:
obtaining, by the forwarding device, the second identification information from the first data structure, and reading, based on the second identification information, the second data structure that is in the first forwarding table and that is connected to the first data structure; and
processing, by the forwarding device, the first packet based on a combination of a first field value type in the first data structure and content corresponding to the first field value type and a combination of a second field value type in the second data structure and content corresponding to the second field value type.

4. The method according to claim 3, wherein the second data structure further includes one piece of third identification information, and the third identification information is used to indicate another second data structure that is in the first forwarding table and that is connected to the second data structure.

5. The method according to claim 2, wherein after the processing, by the forwarding device, the first packet based on a field value type in the at least one data structure and content corresponding to the field value type, the method further includes: obtaining, by the forwarding device based on the first identification information, a second forwarding table configured by the control device, and processing the first packet based on the second forwarding table, to obtain a field value that is in the second forwarding table and that corresponds to a field value type.

6. The method according to claim 1, wherein the content corresponding to the field value type includes protocol indication information, and the protocol indication information is used to indicate a protocol type used for the first packet.

7. The method according to claim 6, wherein the protocol indication information includes at least one of the following:
a virtual local area network VLAN identifier, a media access control MAC address, an internet protocol IP address, a multiprotocol label switching MPLS label, a port number, or an automatic protection switching APS field.

8. The method according to claim 1, wherein the content corresponding to the field value type includes an offset and a length, and the offset and the length are used to indicate a location that is of a field read by the forwarding device and that is in the first packet.

9. The method according to claim 6, wherein the processing, by the forwarding device, the first packet based on a field value type in the at least one data structure and content corresponding to the field value type, to obtain a field value of a field value type includes:
parsing, by the forwarding device, content corresponding to a field value type in a data structure; and
in response to the content corresponding to the field value type being protocol indication information, determining, by the forwarding device based on the protocol indication information, the protocol type used for the first packet, and determining, based on the protocol type used for the first packet, a field value corresponding to the field value type; and/or in response to the content corresponding to the field value type being an offset and a length, reading, by the forwarding device, a field that is located in the first packet and that is indicated by the offset and the length, and determining, based on the field in the first packet, the field value corresponding to the field value type.

10. A forwarding device, comprising a processor and a memory, wherein
the memory stores instructions and is configured to store a plurality of forwarding tables, the plurality of forwarding tables includes a first forwarding table corresponding to a first packet, the first forwarding table includes at least one data structure, and the at least one data structure includes a field value type and content corresponding to the field value type; and
the processor is coupled to the memory, and executes the instructions to process the first packet based on the forwarding tables, to implement packet processing by:
receiving a first packet;
obtaining the first forwarding table; and
processing the first packet based on a field value type in the at least one data structure and content corresponding to the field value type, to obtain a field value of a field value type.

11. The forwarding device according to claim 10, wherein the at least one data structure includes a first data structure, the first data structure includes at least one piece of first identification information, the first identification information is used to indicate a first primary data structure in a second forwarding table connected to the first forwarding table, and the second forwarding table corresponds to the first packet.

12. The forwarding device according to claim 11, wherein the at least one data structure further includes one or more second data structures, the first data structure further includes one piece of second identification information, and the second identification information is used to indicate a second data structure that is in the first forwarding table and that is connected to the first data structure; and
the processor is further configured to execute the instructions for processing the first packet based on a field value type in the at least one data structure and content corresponding to the field value type includes:
obtaining the second identification information from the first data structure, and reading, based on the second identification information, the second data structure that is in the first forwarding table and that is connected to the first data structure; and
processing the first packet based on a combination of a first field value type in the first data structure and content corresponding to the first field value type and a combination of a second field value type in the second data structure and content corresponding to the second field value type.

13. The forwarding device according to claim 12, wherein the second data structure further includes one piece of third identification information, and the third identification information is used to indicate another second data structure that is in the first forwarding table and that is connected to the second data structure.

14. The forwarding device according to claim 11, wherein after the processing the first packet based on a field value type in the at least one data structure and content corresponding to the field value type, the processor is further configured to execute the instructions for: obtaining a second forwarding table based on the first identification information, and processing the first packet based on the second forwarding table, to obtain a field value that is in the second forwarding table and that corresponds to a field value type.

15. The forwarding device according to claim 10, wherein the content corresponding to the field value type includes protocol indication information, and the protocol indication information is used to indicate a protocol type used for the first packet.

16. The forwarding device according to claim 15, wherein the protocol indication information includes at least one of the following:
a virtual local area network VLAN identifier, a media access control MAC address, an internet protocol IP address, a multiprotocol label switching MPLS label, a port number, or an automatic protection switching APS field.

17. The forwarding device according to claim 10, wherein the content corresponding to the field value type includes an offset and a length, and the offset and the length are used to indicate a location that is of a field read by the forwarding device and that is in the first packet.

18. The forwarding device according to claim 15, wherein the processor is further configured to execute the instructions for processing the first packet based on a field value type in the at least one data structure and content corresponding to the field value type, to obtain a field value of a field value type includes:
parsing content corresponding to a field value type in a Adata structure; and
in response to the content corresponding to the field value type being protocol indication information, determining the protocol type used for the first packet based on the protocol indication information, and determining, based on the protocol type used for the first packet, a field value corresponding to the field value type; and in response to the content corresponding to the field value type being an offset and a length, reading a field that is located in the first packet and that is indicated by the offset and the length, and determining, based on the field in the first packet, the field value corresponding to the field value type

19. The forwarding device according to claim 10, wherein the processor includes a first data structure processor and a second data structure processor, wherein
the first data structure processor is configured to process the first packet based on a first field value type in the first data structure and content corresponding to the first field value type, to obtain a first field value of the first field value type in the first data structure; and
the second data structure processor is configured to:
obtain second identification information from the first data structure, and read, based on the second identification information, a second field value type in a second data structure corresponding to the second identification information and content corresponding to the second field value type; and process the first packet based on the second field value type in the second data structure and the content corresponding to the second field value type, to obtain a second field value of the second field value type in the second data structure.

20. A packet processing system, comprising a control device and the forwarding device, wherein the forwarding device includes a processor and a memory,
the memory stores instructions and is configured to store a plurality of forwarding tables, the plurality of forwarding tables includes a first forwarding table corresponding to a first packet, the first forwarding table includes at least one data structure, and the at least one data structure includes a field value type and content corresponding to the field value type; and
the processor is coupled to the memory and is further configured to execute the instructions to processes the first packet based on the forwarding tables, to implement packet processing by:
receiving a first packet;
obtaining the first forwarding table; and
processing the first packet based on a field value type in the at least one data structure and content corresponding to the field value type, to obtain a field value of a field value type;
wherein the control device is adapted to configure the plurality of forwarding tables.
